(19) United States
(12) Patent Application Publication
(10) Pub. No.: US 2026/0149919 A1
(43) Pub. Date: May 28, 2026

(54) SOUND OUTPUT DEVICE, SOUND OUTPUT METHOD, AND PROGRAM

(71) Applicant: KYOCERA Corporation, Kyoto-shi, Kyoto (JP)

(72) Inventors: Shotaro NAGAO, Yokohama-shi, Kanagawa (JP); Toshikazu KANAOKA, Yokohama-shi, Kanagawa (JP); Erika YAMAMOTO, Kawasaki-shi, Kanagawa (JP)

(73) Assignee: KYOCERA Corporation, Kyoto-shi, Kyoto (JP)

(21) Appl. No.: 19/122,670

(22) PCT Filed: Oct. 18, 2023
(86) PCT No.: PCT/JP2023/037722

§ 371 Date: Apr. 18, 2025

(30) Foreign Application Priority Data
Oct. 27, 2022 (JP) 2022-172735

(51) Int. Cl. H04R 3/00

(52) U.S. Cl. CPC H04R 3/00; H04R 2420/01

(57) ABSTRACT

A sound output device includes a storage and a controller. The storage is configured to store external sound data. The controller is configured to divide the external sound data into a plurality of sound segments, localize at least a part of the plurality of sound segments at respective sound image positions, and play the plurality of sound segments by at least partially overlapping the plurality of sound segments in time.

### CROSS-REFERENCE TO RELATED APPLICATIONS

This application claims priority from Japanese Patent Application No. 2022-172735 (filed October 27, 2022), the content of which is all incorporated herein by reference.

TECHNICAL FIELD

The present disclosure relates to a sound output device, a sound output method, and a program.

### BACKGROUND OF INVENTION

Techniques for playing recorded sounds are known. For example, Patent Literature 1 discloses an audio playback device configured to rewind audio in response to a rewind request from a driver.

### CITATION LIST

### Patent Literature

Patent Literature 1: Japanese Unexamined Patent Application Publication No. 2016-119133

### SUMMARY

In an embodiment of the present disclosure, a sound output device includes a storage and a controller.

The storage is configured to store external sound data.

The controller is configured to divide the external sound data into a plurality of sound segments,
localize at least a part of the plurality of sound segments at respective sound image positions, and
play the plurality of sound segments by at least partially overlapping the plurality of sound segments in time.

In an embodiment of the present disclosure, a sound output method includes
storing external sound data;
dividing the external sound data into a plurality of sound segments;
localizing at least a part of the plurality of sound segments at respective sound image positions; and
playing the plurality of sound segments by at least partially overlapping the plurality of sound segments in time.

In an embodiment of the present disclosure, a program is configured to cause a computer to execute a process. The process includes
storing external sound data;
dividing the external sound data into a plurality of sound segments;
localizing at least a part of the plurality of sound segments at respective sound image positions; and
playing the plurality of sound segments by at least partially overlapping the plurality of sound segments in time.

### BRIEF DESCRIPTION OF THE DRAWINGS

FIG. 1 is a diagram illustrating a schematic configuration of a sound output device according to an embodiment of the present disclosure.

FIG. 2 is a diagram illustrating an example of sound image positions relative to a user.

FIG. 3 is a block diagram of the sound output device illustrated in FIG. 1.

FIG. 4 is a flowchart illustrating an example of a procedure of a sound output method according to an embodiment of the present disclosure.

FIG. 5 is a diagram for describing playback of a sound segment according to another embodiment of the present disclosure.

FIG. 6 is a diagram for describing playback of sound segments according to another embodiment of the present disclosure.

FIG. 7 is a diagram for describing playback of sound segments according to another embodiment of the present disclosure.

FIG. 8 is a diagram for describing playback of sound segments according to another embodiment of the present disclosure.

FIG. 9 is a flowchart illustrating an example of a procedure of a sound output method according to another embodiment of the present disclosure.

### DESCRIPTION OF EMBODIMENTS

Techniques known in the art for playing recorded sounds leave room for improvement. For example, in response to a user's operation, a sound being played may be too long or too short. An embodiment of the present disclosure can provide an improved technique for playing a recorded sound.

Hereinafter, embodiments of the present disclosure will be described with reference to the drawings.

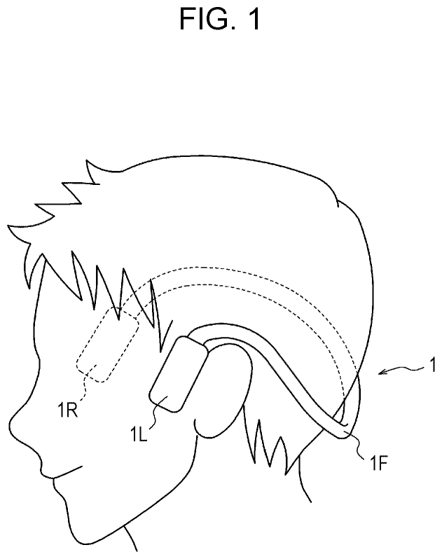

A sound output device 1 as illustrated in FIG. 1 is a hearable device. In an embodiment, the sound output device 1 is a bone conduction earphone. However, the sound output device 1 is not limited to a bone conduction earphone as long as it is a hearable device. Other examples of the sound output device 1 include a clip-on earphone, a neck-hanging loudspeaker, an inner-ear earphone, an intra-canal earphone, and a headphone. The sound output device 1 in a form of an inner-ear earphone or a headphone may have a function of capturing an external sound. The function of capturing an external sound is configured to pick up an external sound outside the sound output device 1 and output the external sound to a user. An external sound is generated outside the sound output device 1. Examples of an external sound include a sound generated around the user. An external sound may be a sound generated by the user.

The sound output device 1 includes a housing 1L, a housing 1R, and a fixing member 1F. The housing 1L is placed against the left temple of the user. The housing 1R is placed against the right temple of the user. The fixing member 1F fixes the housing 1L and the housing 1R to the left and right temples of the user, respectively. The fixing member 1F includes a left ear hook to be hooked on the user's left ear, a right ear hook to be hooked on the user's right ear, and a band that connects these ear hooks. The fixing member 1F may include a housing that can accommodate a communicator 13 and other components described below.

The sound output device 1 is worn on the user's head. The user can hear an external sound while wearing the sound output device 1 on the head. However, the user may fail to catch an external sound containing necessary information while paying attention to other things. For example, while creating a document on a personal computer or reading a book, the user may fail to catch an external sound containing necessary information. Even in such a case, selective attention enables the user to feel that the user has failed to catch an external sound containing necessary information. Selective attention means, for example, selectively paying attention to specific information in an environment where a variety of external sounds are present. In an embodiment, upon feeling that the user has failed to catch an external sound containing necessary information, the user can use a first input described below to cause the sound output device 1 to play the external sound. The user can cause the sound output device 1 to play the external sound to check whether the external sound contains necessary information.

For example, the user is assumed to be on a train. Furthermore, an announcement sound is assumed to be played as an external sound in the train saying “Transfer information. Railway Line A, . . . , Railway Line D, . . . , and Railway Line H, please transfer”. Information regarding “Railway Line D” is assumed to be necessary for the user. In this case, upon feeling that the user has failed to catch the external sound “Railway Line D”, the user can use the first input described below to cause the sound output device 1 to play the announcement sound.

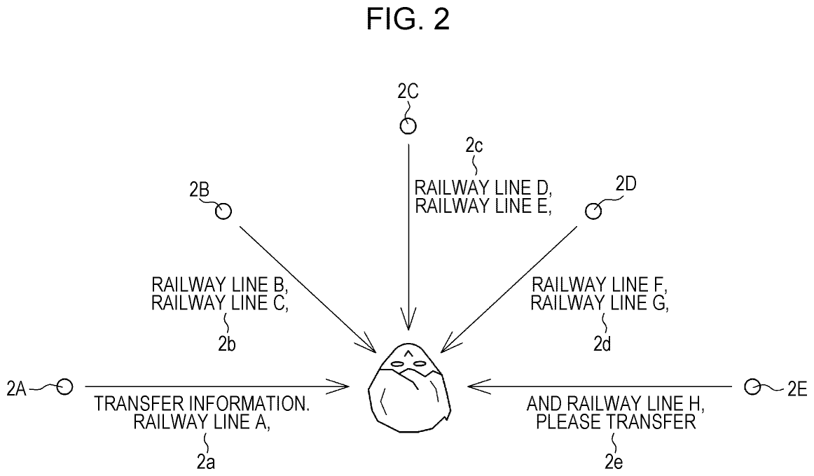

The sound output device 1 is configured to, when playing an external sound, divide external sound data into a plurality of sound segments, localize the plurality of sound segments at respective sound image positions, and play the plurality of sound segments by at least partially overlapping the plurality of sound segments in time. A sound segment is one of a plurality of portions obtained by division of a sound having a predetermined length, such as an external sound, and has a predetermined length. The lengths of the plurality of portions obtained by the division may be the same or different. For example, as illustrated in FIG. 2, the sound output device 1 divides the announcement sound into sound segments 2a, 2b, 2c, 2d, and 2e. The sound segments 2a to 2e are temporally continuous sound segments. The phrase “temporally continuous” means that the sound segments are adjacent to each other in the external sound. The phrase “temporally continuous” may also include overlapping of the trailing portion of the sound segment 2a and the leading portion of the sound segment 2b of the continuous sound segments 2a and 2b. The sound segment 2a includes the leading portion of the announcement sound. The sound segment 2e includes the trailing portion of the announcement sound. The sound segment 2a includes a sound “Transfer information. Railway Line A”. The sound segment 2b includes a sound “Railway Line B, Railway Line C”. The sound segment 2c includes a sound “Railway Line D, Railway Line E”. The sound segment 2d includes a sound “Railway Line F, Railway Line G”. The sound segment 2e includes a sound “and Railway Line H, please transfer”. The sound output device 1 localizes the sound segments 2a, 2b, 2c, 2d, and 2e at sound image positions 2A, 2B, 2C, 2D, and 2E, respectively, that differ from each other and plays the sound segments by at least partially overlapping the sound segments in time. The phrase “to play the sound segments by at least partially overlapping the sound segments in time” means, for example, that at least a portion of the sound segment 2a and a portion of the sound segment 2b are played simultaneously. For example, this procedure includes starting to play the sound segment 2b before playback of the sound segment 2a ends. Since a plurality of sound segments overlapping in time are played, the user can check whether the announcement sound includes information regarding “Railway Line D” in a shorter time than when listening again to the entire announcement sound continuously saying “Transfer information. Railway Line A, Railway Line B, . . . , and Railway Line E, please transfer”.

A sound image position at which a sound segment is localized may be set in consideration of a masking effect. The masking effect is a phenomenon in which one or more sounds among a plurality of sounds are blocked by other sounds and cannot be heard. In the masking effect, a sound that is blocked and cannot be heard among the plurality of sounds is called a “maskee”. A blocking sound among the plurality of sounds is called a “masker”. A sound image position may be set in consideration of directional masking. The directional masking is a phenomenon in which the amount of masking is greater when a maskee and a masker come to a user from the same direction than when the maskee and the masker come to a user from different directions. The amount of masking is the amount of increase in a hearing threshold for the maskee when the masking effect occurs. In an embodiment, the sound output device 1 is configured to localize a plurality of sound segments at respective sound image positions and play the plurality of sound segments, thereby reducing the amount of masking. That is, in FIG. 2, the user can hear the sound segments 2a to 2e separately.

As an example of setting the sound image positions, as illustrated in FIG. 2, the sound image positions 2A to 2E may be set at 45-degree intervals from the left side of the user to the front and to the right side of the user with the user at the center. For a masker and a maskee having a frequency of 1 [kHz], the amount of masking is known to be reduced by about −18 [dB] if the difference between the direction in which the masker comes to the user and the direction in which the maskee comes to the user is about 45 degrees. Thus, for the announcement sound having a frequency of 1 [kHz], the amount of masking can be reduced by about −18 [dB] by setting the sound image positions 2A to 2E at 45-degree intervals as illustrated in FIG. 2. However, examples of setting the sound image positions are not limited to the configuration illustrated in FIG. 2. As another example, the sound image positions may be set behind the user, above the user, or below the user. In addition, intervals between the plurality of sound image positions and a distance between each sound image position and the user are not limited to specific values.

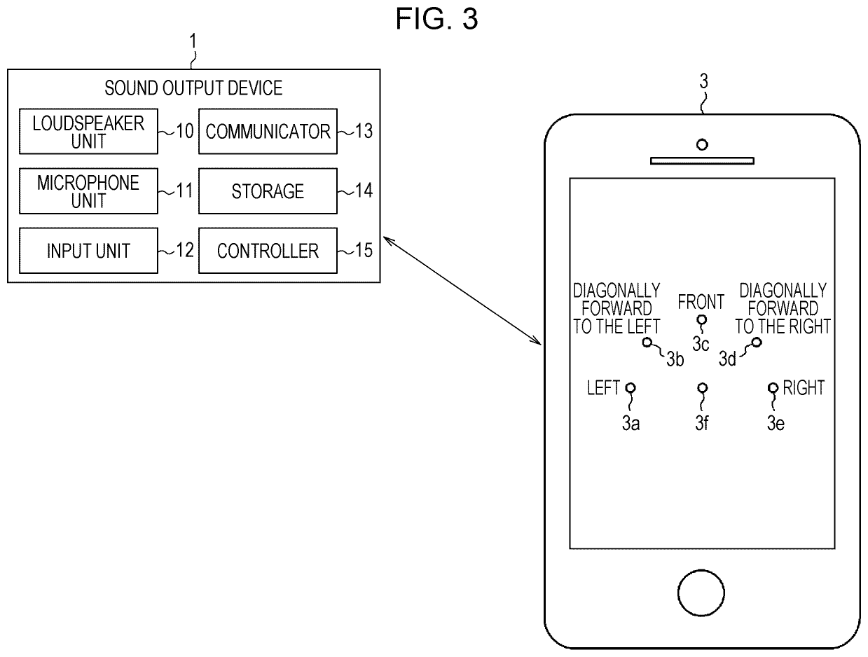

As illustrated in FIG. 3, the sound output device 1 may be capable of communicating with an electronic device 3. The electronic device 3 is used by a user who wears the sound output device 1. Examples of the electronic device 3 include a smartphone. The electronic device 3 may enable the user to configure various settings or perform various operations of the sound output device 1.

As illustrated in FIG. 3, the sound output device 1 includes a loudspeaker unit 10, a microphone unit 11, an input unit 12, the communicator 13, a storage 14, and a controller 15. The communicator 13, the storage 14, and the controller 15 may be housed in either the housing 1L or the housing 1R or may be housed in a housing included in the fixing member 1F, as illustrated in FIG. 1.

The loudspeaker unit 10 is capable of outputting a sound. In an embodiment, the loudspeaker unit 10 includes a bone conduction loudspeaker on the left-hand side and a bone conduction loudspeaker on the right-hand side. A bone conduction loudspeaker is configured to transmit vibration to a user's skull to output a sound to the user. The bone conduction loudspeaker on the left-hand side is housed in the housing 1L. The bone conduction loudspeaker on the right-hand side is housed in the housing 1R.

The microphone unit 11 is capable of picking up an external sound around the sound output device 1. The microphone unit 11 includes a microphone on the left-hand side and a microphone on the right-hand side. The microphone on the left-hand side is housed in the housing 1L. The microphone on the right-hand side is housed in the housing 1R. The microphone unit 11 is configured to cause the microphone on the left-hand side and the microphone on the right-hand side to pick up an external sound as a stereo sound.

The input unit 12 is capable of receiving an input from the user. The input unit 12 includes at least one input interface capable of receiving an input from the user. Examples of the at least one input interface include a physical key, a capacitive key, an inertial sensor, an optical sensor, and a microphone. The physical key and the capacitive key may be disposed on a surface of either the housing 1L or the housing 1R. The inertial sensor, the optical sensor, and the microphone may be housed in either the housing 1L or the housing 1R or may be housed in a housing included in the fixing member 1F, as illustrated in FIG. 1.

When the input unit 12 includes a physical key or a capacitive key, the input unit 12 receives a user operation on the physical key or the capacitive key as an input from the user.

When the input unit 12 includes an inertial sensor, an optical sensor, or a microphone, the input unit 12 is capable of detecting the user's gesture. When the input unit 12 includes an inertial sensor, examples of the gesture may include tilting a head. When the input unit 12 includes an optical sensor, examples of the gesture may include holding a hand over the optical sensor. When the input unit 12 includes a microphone, examples of the gesture may include tapping the microphone. The input unit 12 is configured to receive a detected gesture as an input from the user.

The communicator 13 includes at least one communication module capable of communicating with the electronic device 3. The at least one communication module supports, for example, a short-range wireless communication standard such as Bluetooth (registered trademark).

The storage 14 includes at least one semiconductor memory, at least one magnetic memory, at least one optical memory, or a combination of at least two types of these memories. Examples of the at least one semiconductor memory include a RAM (random access memory) and a ROM (read only memory). Examples of the RAM include an SRAM (static random access memory) and a DRAM (dynamic random access memory). Examples of the ROM include an EEPROM (electrically erasable programmable read only memory). The storage 14 may serve as a main storage device, an auxiliary storage device, or a cache memory. The storage 14 is configured to store data to be used for operation of the sound output device 1 and data obtained by operation of the sound output device 1.

The controller 15 includes at least one processor, at least one dedicated circuit, or a combination thereof. The at least one processor is a general-purpose processor, such as a CPU (central processing unit) or a GPU (graphics processing unit), or a dedicated processor configured to specialize in specific processing. Examples of the at least one dedicated circuit include an FPGA (field-programmable gate array) and an ASIC (application specific integrated circuit). The controller 15 is configured to perform a process concerning the operation of the sound output device 1 while controlling each unit in the sound output device 1.

The controller 15 is configured to cause the microphone unit 11 to pick up an external sound around the sound output device 1, that is, around the user. As described above, the external sound picked up by the microphone unit 11 is a stereo sound. The controller 15 is configured to store data of the picked-up stereo sound in the storage 14. The controller 15 may store in the storage 14 data of a stereo sound during a predetermined time interval that ends at a current time. The predetermined time interval is longer than a preset time interval, which will be described later. The predetermined time interval is, for example, two minutes. The storage 14 may include a ring buffer for storing data of a stereo sound. Data of a stereo sound older than the predetermined time interval may successively be deleted from the ring buffer.

The controller 15 is able to cause the input unit 12 to receive the first input. The first input is an input for dividing an external sound during a preset time interval that ends at a current time into a plurality of sound segments and for playing the external sound. Upon feeling that the user has failed to catch an external sound containing necessary information, the user enters the first input into the input unit 12. The preset time interval may be set in advance by the user or may be set in advance in accordance with specifications of the sound output device 1. The preset time interval is, for example, 30 seconds.

Upon receiving the first input, the controller 15 retrieves from the storage 14 data of a stereo sound during a preset time interval that ends at a current time. For example, in FIG. 2, the controller 15 retrieves data of an announcement sound saying “Transfer information. Railway Line A, . . . , Railway Line D, . . . , and Railway Line H, please transfer” as data of a stereo sound during a preset time interval that ends at a current time. The controller 15 is configured to convert the retrieved data of the stereo sound into data of a mono sound.

The controller 15 is configured to divide the data of the mono sound after the conversion into a plurality of sound segments. The number of the plurality of sound segments after the division may be set based on the length of the preset time interval or the number of sound image positions that is set in advance. For example, the controller 15 divides the announcement sound into five sound segments, that is, the sound segments 2a to 2e in FIG. 2.

As an example of the division process, the controller 15 may divide the data of the mono sound into a plurality of sound segments by dividing the data of the mono sound at equal time intervals. This time interval may be set based on the length of the preset time interval and the number of sound image positions that is set in advance. This time interval is, for example, 6 seconds.

As another example of the division process, the controller 15 may detect a speech section to divide the data of the mono sound into a plurality of sound segments. The speech section is a section during which speaking continues. People usually pause for breath or when they reach a punctuation mark or the like while speaking. Such a position at which people pause may be regarded as a boundary of a speech section. Regarding a position at which pausing occurs as a boundary of a speech section enables the controller 15 to detect a speech section in word units that is not divided in the middle of speaking, while excluding a silent section where no speaking occurs. When the number of detected speech sections is greater than the number of sound image positions that is set in advance, the controller 15 may merge a plurality of temporally continuous speech sections into one sound segment so that the number of the plurality of sound segments after the division agrees with the number of the sound image positions. Alternatively, the controller 15 may merge a plurality of temporally continuous speech sections into one sound segment so that the differences among the lengths of the plurality of sound segments after the division fall within a predetermined range. The predetermined range may be, for example, 1 second or less.

As still another example of the division process, the controller 15 may perform a voice recognition process on the data of the mono sound and divide the data of the mono sound into a plurality of sound segments on a word-by-word basis. The controller 15 may combine a plurality of temporally continuous words into one so that the number of the plurality of sound segments after the division agrees with the number of the sound image positions or the differences among the lengths of the plurality of sound segments after the division fall within the predetermined range.

The controller 15 may determine the number and the arrangement of the sound image positions in accordance with the number of the plurality of sound segments after the division. For example, when dividing the announcement sound into the five sound segments, that is, the sound segments 2a to 2e, as illustrated in FIG. 2, the controller 15 determines that sound image positions are to be arranged in five different angular directions at 45-degree intervals around the user at the center.

Upon dividing the announcement sound into the plurality of sound segments, the controller 15 determines whether sound segments having sound frequencies close to each other are present among the plurality of sound segments after the division. The sound segments having frequencies close to each other are, for example, sound segments for which differences between the lowest frequency and the other frequencies are equal to a threshold value or less among the frequencies of the plurality of sound segments. The sound segments having frequencies close to each other may be, for example, sound segments for which differences among average frequencies of the sound segments are equal to a threshold value or less. The threshold value may be set in consideration of frequency masking. The frequency masking is a phenomenon in which the amount of masking increases as the frequency of the masker and the frequency of the maskee become closer. The threshold value is set, for example, based on the difference between the frequency of the masker and the frequency of the maskee when an allowable amount of masking is obtained. Upon determining that sound segments having sound frequencies close to each other are present, the controller 15 varies the frequencies of the sound segments until, for example, the amount of masking is reduced to an allowable level. The controller 15 may set frequencies of one or more sound segments at higher or lower values than frequencies of the other sound segments among the sound segments having sound frequencies close to each other. For example, when the frequencies of the sound segments 2a to 2e as illustrated in FIG. 2 are close to each other, the controller 15 may gradually increase or decrease the frequency from the frequency of the sound segment 2a to the frequency of the sound segment 2e. The masking effect is known to usually make sounds having high frequencies harder to hear than sounds having low frequencies. Thus, when setting the frequencies of the one or more sound segments at values higher than the frequencies of the other sound segments, the controller 15 may increase an amount of change in frequency than when setting the frequencies at lower values. The controller 15 may divide a sound into a plurality of sound segments or change sound frequencies and then adjust volume levels of the plurality of sound segments so that each of the plurality of sound segments sounds equally to the user.

The controller 15 is configured to, via the loudspeaker unit 10, localize the plurality of sound segments at respective sound image positions and play the plurality of sound segments by at least partially overlapping the plurality of sound segments in time. For example, the controller 15 is configured to adjust the volume level of a sound that is output from the bone conduction loudspeaker on the left-hand side of the loudspeaker unit 10 and the volume level of a sound that is output from the bone conduction loudspeaker on the right-hand side of the loudspeaker unit 10 to localize the plurality of sound segments at respective sound image positions. The controller 15 may make a start timing of playing each of the plurality of sound segments different based on temporal masking. Temporal masking is a phenomenon in which, when a masker is generated, the masking effect continues from 20 [ms] before the generation of the masker until 100 [ms] after the generation of the masker. For example, in FIG. 2, the controller 15 may shift a start timing of playing each of the sound segments 2 a to 2 e by 100 [ms] or more. The controller 15 may delay a start timing of playback by 100 [ms] for each sound segment from the sound segment 2 a to the sound segment 2 e. In this case, the sound segment 2 b starts to be played 100 [ms] later than the sound segment 2 a. The sound segment 2 c starts to be played 100 [ms] later than the sound segment 2 b. The sound segment 2 d starts to be played 100 [ms] later than the sound segment 2 e. The controller 15 may expedite a start timing of playback by 100 [ms] for each sound segment from the sound segment 2a to the sound segment 2e.

The controller 15 may localize two temporally continuous sound segments among the plurality of sound segments at two adjacent sound image positions among the plurality of sound image positions. The two adjacent sound image positions may be two sound image positions located closest to each other among the plurality of sound image positions. When sound image positions are arranged according to a predetermined rule, sound image positions located next to each other in the direction of arrangement may be considered adjacent sound image positions. For example, in FIG. 2, the controller 15 localizes the temporally continuous sound segments 2a and 2b at the adjacent sound image positions 2A and 2B, respectively, and localizes the temporally continuous sound segments 2b and 2c at the adjacent sound image positions 2B and 2C, respectively. The controller 15 localizes the temporally continuous sound segments 2c and 2d at the adjacent sound image positions 2C and 2D, respectively, and localizes the temporally continuous sound segments 2d and 2e at the adjacent sound image positions 2D and 2E, respectively.

The controller 15 may play the plurality of sound segments and then cause the input unit 12 to receive an input from the user to select any one of the plurality of sound segments. For example, by listening to the plurality of sound segments that have been played, the user can confirm that the announcement sound contains information regarding “Railway Line D” as illustrated in FIG. 2. In this case, the user wants to listen again to the external sound beginning at “Railway Line D”. The user enters an input into the input unit 12 to select the sound segment 2c among the sound segments 2a to 2e.

The input for selecting any one of the plurality of sound segments may be an input indicating a sound image position. For example, the input for selecting the sound segment 2c may be an input indicating the sound image position 2C. In this case, the controller 15 may cause the input unit 12 to detect a gesture indicating a sound image position to receive an input indicating the sound image position. For example, when the input unit 12 includes a microphone, the gesture may be the number of times that the microphone is tapped. The number of times that the microphone is tapped may correspond to, for example, which sound image position, counting from the right of the user. As another example, when the input unit 12 includes an inertial sensor, the gesture may be tilting the head toward the sound image position.

The electronic device 3 may be used instead of the input unit 12. In this case, the controller 15 is configured to cause the communicator 13 to transmit information regarding sound image positions to the electronic device 3. Upon receiving the information regarding sound image positions, the electronic device 3 displays an image indicating the sound image positions relative to the user. For example, as illustrated in FIG. 3, the electronic device 3 displays an image indicating positions 3a, 3b, 3c, 3d, 3e, and 3f. The positions 3a to 3e correspond to the sound image positions 2A to 2e, respectively, as illustrated in FIG. 2. The position 3f corresponds to the user's location. The positions 3a to 3e are labeled with the characters “left”, “diagonally forward to the left”, “front”, “diagonally forward to the right”, and “right”, respectively. The user views the screen of the electronic device 3 and touches the position indicating the sound image position of the sound segment to be selected. For example, when the sound segment 2c is to be selected, the user taps the position 3c indicating the sound image position 2C. Upon detecting a tap on a position, the electronic device 3 transmits a signal indicating a sound image position corresponding to the tapped position to the sound output device 1. The controller 15 causes the communicator 13 to receive the signal indicating the sound image position to receive an input indicating the sound image position from the user.

Upon receiving the input to select any one of the plurality of sound segments, the controller 15 plays the external sound beginning at the selected sound segment via the loudspeaker unit 10. After playing the sound segment selected by the user, the controller 15 may play a part or all of a sound segments following the sound segment selected by the user among the plurality of sound segments after the division. A sound segment following in time may be a sound segment following in the direction in which time elapses. For example, the sound segment 2c as illustrated in FIG. 2 is assumed to be selected. In this case, the controller 15 plays the external sound corresponding to the sound segment 2c to the sound segment 2e, that is, the external sound “Railway Line D, Railway Line E, . . . , and Railway Line H, please transfer”. In response to the user input received from the input unit 12, the controller 15 may make the playback speed of the external sound beginning at the selected sound segment faster than the normal playback speed.

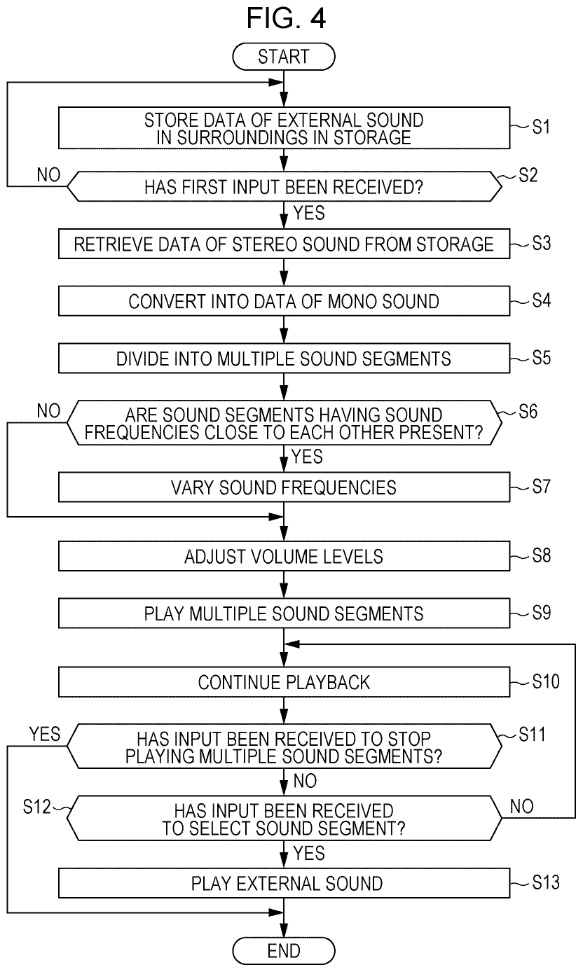

FIG. 4 is a flowchart illustrating an example of a procedure of a sound output method according to an embodiment of the present disclosure. For example, in response to a power supply of the sound output device 1 being turned on, the controller 15 starts the process in step S1.

The controller 15 causes the microphone unit 11 to pick up as a stereo sound an external sound around the sound output device 1, that is, around the user. The controller 15 stores in the storage 14 external sound data, which is data of the external sound picked up as a stereo sound (step S1).

The controller 15 determines whether the first input has been received by the input unit 12 (step S2). If the controller 15 determines that the first input has been received (step S2: YES), the controller 15 proceeds to the process in step S3. In contrast, if the controller 15 does not determine that the first input has been received (step S2: NO), the controller 15 returns to the process in step S1.

In the process in step S3, the controller 15 retrieves from the storage 14 data of a stereo sound during the preset time interval that ends at the current time. The controller 15 converts the data of the stereo sound retrieved in the process in step S3 into data of a mono sound (step S4). The controller 15 divides the data of the mono sound after the conversion into a plurality of sound segments (step S5).

The controller 15 determines whether sound segments having sound frequencies close to each other are present among the plurality of sound segments (step S6).

If the controller 15 determines that sound segments having sound frequencies close to each other are present (step S6: YES), the controller 15 proceeds to the process in step S7. In the process in step S7, the controller 15 varies the frequencies of the sound segments until the amount of masking is reduced to an allowable level.

If the controller 15 does not determine that sound segments having sound frequencies close to each other are present (step S6: NO), the controller 15 proceeds to the process in step S8.

In the process in step S8, the controller 15 adjusts the volume levels of the plurality of sound segments so that each of the plurality of sound segments sounds equally to the user.

Via the loudspeaker unit 10, the controller 15 localizes the plurality of sound segments at respective sound image positions and plays the plurality of sound segments by at least partially overlapping the plurality of sound segments in time (step S9). The controller 15 continues playing the plurality of sound segments (step S10).

The controller 15 determines whether an input has been received to stop playing the plurality of sound segments (step S11). If the controller 15 determines that an input has been received to stop playing the plurality of sound segments (step S11: YES), the controller 15 ends the process of the sound output method as illustrated in FIG. 4. If the controller 15 does not determine that an input has been received to stop playing the plurality of sound segments (step S11: NO), the controller 15 proceeds to the process in step S12.

In the process in step S12, the controller 15 determines whether an input has been received by the input unit 12 to select any one of the plurality of sound segments.

If the controller 15 determines that an input has been received to select any one of the plurality of sound segments (step S12: YES), the controller 15 proceeds to the process in step S13. In the process in step S13, the controller 15 plays the external sound beginning at the selected sound segment via the loudspeaker unit 10. Such a process in step S13 causes the external sound to start being played beginning at the selected sound segment. After the process in step S13, the controller 15 ends the process of the sound output method as illustrated in FIG. 4.

If the controller 15 does not determine that an input has been received to select any one of the plurality of sound segments (step S12: NO), the controller 15 returns to the process in step S10. While the controller 15 repeatedly executes the process from step S10 to step S12, playback of the plurality of sound segments may end before the controller 15 receives an input to stop playing the plurality of sound segments or an input to select any one of the plurality of sound segments. In this case, the controller 15 may end the process of the sound output method as illustrated in FIG. 4 when a predetermined time has elapsed since the execution of the process in step S9. The predetermined time may be set by the user or may be set in accordance with specifications of the sound output device 1.

After the process of the sound output method as illustrated in FIG. 4, the controller 15 may resume the process from step S1 at any time.

In this manner, in the sound output device 1, the controller 15 divides the external sound data into the plurality of sound segments, localizes at least a part of the plurality of sound segments at respective sound image positions, and plays the plurality of sound segments by at least partially overlapping the plurality of sound segments in time. In an embodiment, as at least a part of the plurality of sound segments, the controller 15 localizes the plurality of sound segments after the division at respective sound image positions and plays the plurality of sound segments by at least partially overlapping the plurality of sound segments in time. For example, as illustrated in FIG. 2, the controller 15 localizes the sound segments 2a to 2e at the sound image positions 2A to 2E, respectively, which differ from each other, and plays the sound segments 2a to 2e by at least partially overlapping the sound segments 2a to 2e in time. Localizing the plurality of sound segments at the respective sound image positions enables the user to hear the plurality of sound segments separately.

In a comparative example, external sound data is to be rewound for a time period specified by the user and then played. In such a comparative example, when the user specifies a long time period, the user needs to listen to all of the external sound data corresponding to the time period to search for necessary information. For example, the user is assumed to need information regarding “Railway Line D” as illustrated in FIG. 2. The user is assumed to rewind the external sound data for a time period corresponding to the announcement sound saying “Transfer information. Railway Line A, . . . , Railway Line D, . . . , and Railway Line H, please transfer”. In this case, the user needs to listen again to the entire announcement sound saying “Transfer information. Railway Line A, . . . , Railway Line D, . . . , and Railway Line H, please transfer” to check whether information regarding “Railway Line D” is contained. When the user specifies a short time period, the user needs to rewind the external sound data many times until the necessary information is found. In the example of the announcement sound above, the user needs to rewind the announcement sound many times until the sound “Railway Line D” is played.

In contrast to such a comparative example, in an embodiment, the controller 15 plays the plurality of sound segments by at least partially overlapping the plurality of sound segments in time. Playing the plurality of sound segments by at least partially overlapping the plurality of sound segments in time enables the user to quickly check the content of the external sound. For example, the user can check whether the information regarding “Railway Line D” is contained in the announcement sound in a shorter time period than when the user needs to listen again to the entire announcement sound saying “Transfer information. Railway Line A, . . . , Railway Line D, . . . , and Railway Line H, please transfer”. Playing the plurality of sound segments by at least partially overlapping the plurality of sound segments in time enables the user to avoid the necessity to rewind the external sound data many times until the necessary information is found as in the comparative example.

Thus, an embodiment can provide an improved technique for playing a recorded sound.

In an embodiment, the controller 15 may make a start timing of playing each of the plurality of sound segments different. The controller 15 may make a start timing of playing each of the plurality of sound segments different based on temporal masking. This configuration reduces the amount of masking and enables the user to hear more clearly each of the plurality of sound segments separately.

In an embodiment, the controller 15 may play the plurality of sound segments at frequencies that differ from each other. Upon determining that sound segments having sound frequencies close to each other are present, the controller 15 may vary the frequencies of the sound segments until, for example, the amount of masking is reduced to an allowable level. This process enables the controller 15 to play the plurality of sound segments at a frequency that differs from a frequency of a corresponding part in the external sound. Playing the plurality of sound segments at frequencies that differ from each other reduces the amount of masking and enables the user to hear more clearly each of the plurality of sound segments separately.

In an embodiment, the controller 15 may localize two temporally continuous sound segments among the plurality of sound segments at two adjacent sound image positions among the plurality of sound image positions. For example, in FIG. 2, as described above, the controller 15 may localize the temporally continuous sound segments 2a and 2b at the adjacent sound image positions 2A and 2B, respectively. Localizing the two temporally continuous sound segments at the two adjacent sound image positions enables the user to grasp a temporal relationship between the sound segments.

In an embodiment, the controller 15 may play the external sound beginning at a sound segment selected by the user among the plurality of sound segments that have been played. The controller 15 may play a sound segment following the sound segment selected by the user, after playing the sound segment selected by the user among the plurality of sound segments after the division. For example, when the sound segment 2c as illustrated in FIG. 2 is selected, the controller 15 plays the external sound corresponding to the sound segment 2c to the sound segment 2e, that is, the external sound saying “Railway Line D, Railway Line E, . . . , and Railway Line H, please transfer”. This configuration enables the user to check the details of the necessary information.

In an embodiment, when dividing the external sound data, the controller 15 may divide the external sound data into the plurality of sound segments by dividing the external sound data at equal time intervals. By dividing the external sound data at equal time intervals, the lengths of the plurality of sound segments after the division can be made equal. Making the lengths of the plurality of sound segments after the division equal enables the user to pay attention equally to each of the plurality of sound segments when the plurality of sound segments are played.

### Other Embodiments

The controller 15 may cause the input unit 12 to receive a second input. The second input is an input for rewinding and playing the external sound, sound segment by sound segment. The controller 15 may receive the second input a plurality of times.

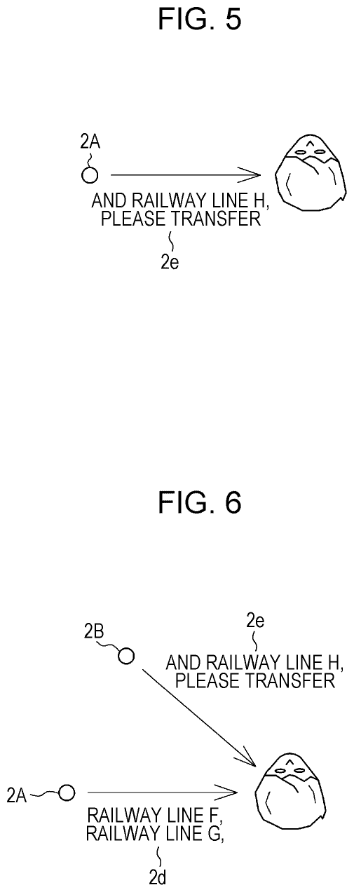

Upon receiving the second input for the first time, the controller 15 retrieves from the storage 14 data of a stereo sound during a preset time interval that ends at a current time in a process identical or similar to the process described above. The controller 15 converts the retrieved data of the stereo sound into data of a mono sound and divides the data of the mono sound after the conversion into a plurality of sound segments in a process identical or similar to the process described above. Upon receiving the second input for the first time, the controller 15 plays via the loudspeaker unit 10 the most recent sound segment among the plurality of sound segments after the division. The most recent sound segment includes the trailing portion of the external sound, which is the mono sound before the division. For example, the plurality of sound segments after the division are assumed to include the sound segments 2a to 2e as illustrated in FIG. 2. In this case, upon receiving the second input for the first time, the controller 15 plays via the loudspeaker unit 10 the most recent sound segment 2e among the sound segments 2a to 2e as illustrated in FIG. 5. The controller 15 localizes the sound segment 2e at the sound image position 2A. When the user listens to the sound segment played and thinks that the sound segment played does not contain the information to be checked, the user further enters the second input into the input unit 12. The controller 15 may receive the second input during playback of the sound segment or may receive the second input within a predetermined time period after the end of the playback of the sound segment. The predetermined time period may be set in consideration of the user's convenience.

Upon receiving the second input next, the controller 15 plays via the loudspeaker unit 10 the sound segment that has been played and the sound segment preceding the sound segment that has been played. At this time, the controller 15 localizes the sound segment that has been played and the sound segment preceding the sound segment that has been played at respective sound image positions and plays these sound segments by at least partially overlapping these sound segments in time. For example, the controller 15 is assumed to receive the second input during the playback of the sound segment 2e as illustrated in FIG. 5 or within the predetermined time period after the end of the playback of the sound segment 2e. In this case, as illustrated in FIG. 6, the controller 15 plays via the loudspeaker unit 10 the sound segment 2e, which has been played, and the sound segment 2d, which precedes the sound segment 2e in the external sound. The controller 15 localizes the sound segment 2e at the sound image position 2B and localizes the sound segment 2d at the sound image position 2A. That is, of the sound segments 2d and 2e to be played, the controller 15 localizes the oldest sound segment 2d in the announcement sound at the sound image position 2A, which is a specific sound image position. When the user listens to the sound segments played and thinks that the sound segments played do not contain the information to be checked, the user further enters the second input into the input unit 12. The controller 15 may receive the second input during playback of the sound segments or may receive the second input within the predetermined time period after the end of the playback of the sound segments in a process identical or similar to the process described above.

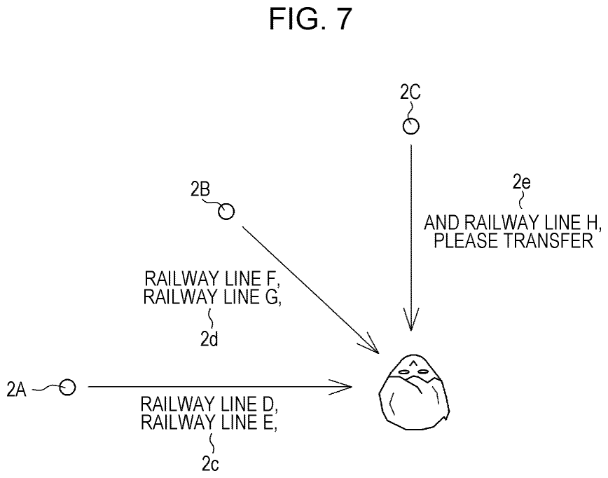

Upon further receiving the second input, the controller 15 plays via the loudspeaker unit 10 the sound segments that have been played and the sound segment preceding the sound segments that have been played in the external sound in a process identical or similar to the process described above. For example, after playing the sound segments 2e and 2d as illustrated in FIG. 6, the controller 15 is assumed to receive the second input. In this case, as illustrated in FIG. 7, the controller 15 plays via the loudspeaker unit 10 the sound segments 2e and 2d, which have been played, and the sound segment 2c, which precedes the sound segment 2d in the external sound. The controller 15 localizes the sound segment 2e at the sound image position 2C, localizes the sound segment 2d at the sound image position 2B, and localizes the sound segment 2c at the sound image position 2A. That is, of the sound segments 2c, 2d and 2e to be played, the controller 15 localizes the oldest sound segment 2c in the announcement sound at the sound image position 2A, which is the specific sound image position.

In this way, upon receiving the second input multiple times, of the plurality of sound segments after the division, the controller 15 localizes at respective sound image positions that differ from each other the same number of sound segments as the number of times that the second input has been received, and the controller 15 plays the sound segments by at least partially overlapping the sound segments in time. Every time of the receipt of the second input, while playing a sound segment that has been played among the plurality of sound segments, the controller 15 additionally plays the sound segment preceding the sound segment that has been played in the external sound. The controller 15 additionally plays the sound segment preceding the sound segment that has been played the fewest times among the sound segments that have been played.

For example, in FIG. 6, while playing the sound segment 2e, which has been played in the configuration illustrated in FIG. 5, the controller 15 additionally plays the sound segment 2d, which precedes the sound segment 2e, which has been played.

For example, in FIG. 7, while playing the sound segments 2d and 2e, which have been played in the configuration illustrated in FIG. 6, the controller 15 additionally plays the sound segment 2c, which precedes the sound segment 2d, which has been played. In FIG. 7, the sound segment 2e has been played twice in the configurations illustrated in FIG. 5 and FIG. 6. The sound segment 2d has been played once in the configuration illustrated in FIG. 6. That is, in FIG. 7, of the sound segments 2d and 2e, which have been played, the sound segment 2d has been played fewer times than the sound segment 2e. Thus, in FIG. 7, the controller 15 additionally plays the sound segment 2c, which precedes the sound segment 2d, which has been played the fewest times among the sound segments 2d and 2e, which have been played.

When playing the plurality of sound segments, the controller 15 may fix the sound image position at which a sound segment to be additionally played is localized. For a sound segment that has been played, the controller 15 may change the sound image position at which the sound segment is localized depending on the number of times that the sound segment has been played. For example, the controller 15 may shift in a predetermined rotation direction around the user the sound image position at which a sound segment is localized as the number of times that the sound segment has been played increases. For example, in FIG. 5 to FIG. 7, the controller 15 fixes at the sound image position 2A the sound image position at which a sound segment to be additionally played is localized. That is, in FIG. 6, the sound segment 2d to be additionally played is localized at the sound image position 2A, and in FIG. 7, the sound segment 2c to be additionally played is localized at the sound image position 2A. The controller 15 shifts in a clockwise direction around the user the sound image position at which a sound segment is localized as the number of times that the sound segment has been played increases. For example, in the configuration illustrated in FIG. 6, the sound segment 2e has been played once in the configuration illustrated in FIG. 5. In the configuration illustrated in FIG. 7, the sound segment 2e has been played twice in the configurations illustrated in FIG. 5 and FIG. 6. The sound image position 2C, at which the sound segment 2e is localized in FIG. 7, is shifted clockwise from the sound image position 2A around the user compared with the sound image position 2B, at which the sound segment 2e is localized in FIG. 6.

When playing the plurality of sound segments, the controller 15 may adjust a volume level of a sound segment in such a manner that the volume level of the sound segment decreases as the number of times that the sound segment has been played increases. The degree of volume level reduction may be set in consideration of the user's convenience. For example, in the configuration illustrated in FIG. 7, the sound segment 2e has been played twice in the configurations illustrated in FIG. 5 and FIG. 6, the sound segment 2d has been played once in the configuration illustrated in FIG. 6, and the sound segment 2c is additionally played. The controller 15 adjusts the volume levels, resulting in the sound segments 2c, 2d, and 2e in order of descending volume level.

The controller 15 need not play a sound segment if the volume level of the sound segment falls below a volume level threshold as a result of reducing the volume level of the sound segment depending on the number of times that the sound segment has been played.

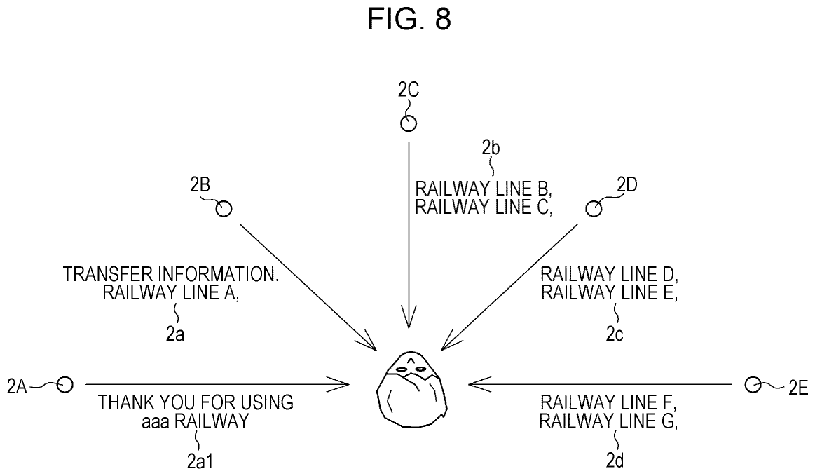

The volume level threshold may be set based on the volume level at which a user can pay attention. For example, in the configuration illustrated in FIG. 8, the sound segments after the division include a sound segment 2a1 saying “Thank you for using aaa Railway” in addition to the sound segments 2a to 2e. The sound segment 2a1 is a sound segment preceding the sound segment 2a. In FIG. 8, the volume level of the sound segment 2e is decreased as the number of times of playback increases, and as a result, the volume level of the sound segment 2e falls below the volume level threshold. Thus, the controller 15 does not play the sound segment 2e.

The controller 15 may localize a sound segment that has been played and another sound segment preceding the sound segment that has been played at sound image positions in accordance with a temporal order of the sound segment that has been played and the other sound segment preceding the sound segment that has been played in the external sound. For example, in the configuration illustrated in FIG. 8, the old sound segment 2a1 to the new sound segment 2d in the announcement sound are localized at the sound image positions 2A to 2E in this order.

When playing the plurality of sound segments, the controller 15 may determine whether sound segments having sound frequencies close to each other are present among the plurality of sound segments to be played in a process identical or similar to the process described above. Upon determining that sound segments having sound frequencies close to each other are present, the controller 15 may vary the frequencies of the sound segments until the amount of masking is reduced to an allowable level in a process identical or similar to the process described above.

When playing the plurality of sound segments, the controller 15 may make a start timing of playing each of the plurality of sound segments different based on temporal masking in a process identical or similar to the process described above.

Even when the controller 15 receives the second input, the controller 15 may stop playing sound segments if all of the plurality of sound segments after the division have been played.

The controller 15 may cause the input unit 12 to receive an input from the user to select any one of the plurality of sound segments that have been played in a process identical or similar to the process described above. Upon receiving an input to select any one of the plurality of sound segments that have been played, the controller 15 may play via the loudspeaker unit 10 the external sound beginning at the selected sound segment in a process identical or similar to the process described above.

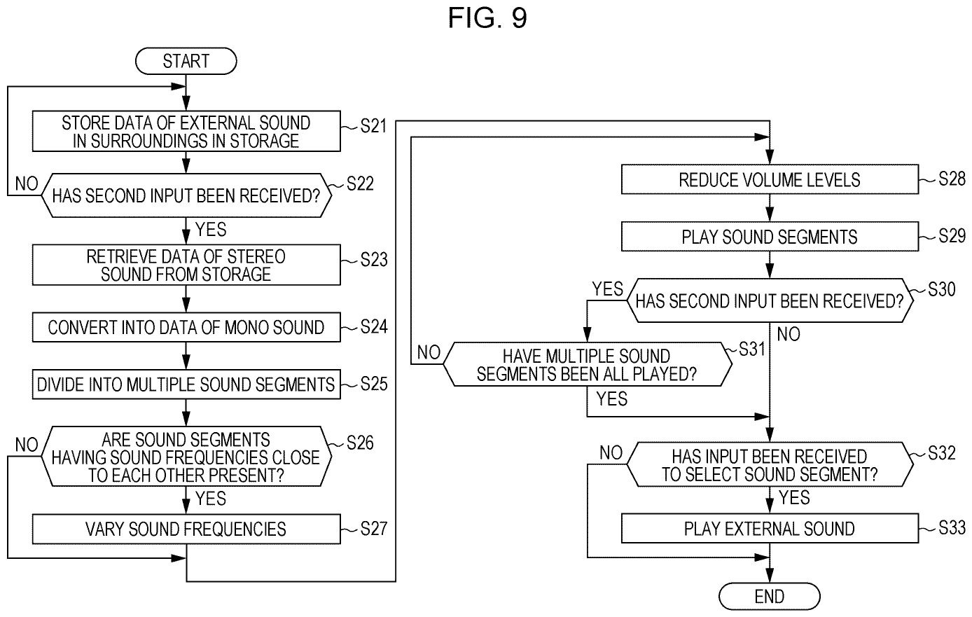

FIG. 9 is a flowchart illustrating an example of a procedure of a sound output method according to another embodiment of the present disclosure. For example, in response to the power supply of the sound output device 1 being turned on, the controller 15 starts the process in step S21.

The controller 15 executes step S21 in a process identical or similar to the process in step S1 as illustrated in FIG. 4.

The controller 15 determines whether the second input has been received by the input unit 12 (step S22). If the controller 15 determines that the second input has been received (step S22: YES), the controller 15 proceeds to the process in step S23. In contrast, if the controller 15 does not determine that the second input has been received (step S22: NO), the controller 15 returns to the process in step S21.

The controller 15 executes steps S23, S24, S25, S26, and S27 in a process identical or similar to the process described above in step S3, S4, S5, S6, and S7 as illustrated in FIG. 4. However, after the process in step S27, the controller 15 proceeds to the process in step S28. If the controller 15 does not determine that sound segments having sound frequencies close to each other are present (step S26: NO), the controller 15 proceeds to the process in step S28.

The controller 15 adjusts the volume levels of sound segments in such a manner that the volume level of a sound segment decreases as the number of times that the sound segment has been played increases (step S28). When the number of sound segments to be played is one, that is, when the second input is received for the first time, the controller 15 need not execute the process in step S28.

Via the loudspeaker unit 10, the controller 15 localizes the sound segments at respective sound image positions and plays the sound segments by at least partially overlapping the sound segments in time (step S29).

In the process in step S29, the controller 15 may fix the sound image position at which a sound segment to be additionally played is localized as described above. For a sound segment that has been played, the controller 15 may change the sound image position at which the sound segment is localized depending on the number of times that the sound segment has been played.

In the process in step S29, the controller 15 need not play a sound segment if the volume level of the sound segment falls below a volume level threshold as a result of the process in step S28.

The controller 15 determines whether the second input has been received by the input unit 12 (step S30). If the controller 15 determines that the second input has been received (step S30: YES), the controller 15 proceeds to the process in step S31. In contrast, if the controller 15 does not determine that the second input has been received (step S30: NO), the controller 15 proceeds to the process in step S32.

In the process in step S31, the controller 15 determines whether all of the plurality of sound segments obtained by the division in the process in step S25 have been played. If the controller 15 determines that all of the plurality of sound segments have been played (step S31: YES), the controller 15 proceeds to the process in step S32. In contrast, if the controller 15 does not determine that all of the plurality of sound segments have been played (step S31: NO), the controller 15 proceeds to the process in step S28.

The controller 15 executes steps S32 and S33 in a process identical or similar to the process in step S12 and S13 as illustrated in FIG. 4. However, if the controller 15 does not determine that an input has been received to select any one of the plurality of sound segments (step S32: NO), the controller 15 ends the process of the sound output method as illustrated in FIG. 9.

In this way, in the sound output device 1 according to another embodiment, as at least a part of the plurality of sound segments, the controller 15 localizes at respective sound image positions that differ from each other the same number of sound segments as the number of times that the second input has been received, and the controller 15 plays the sound segments by at least partially overlapping the sound segments in time. Localizing the sound segments at the respective sound image positions that differ from each other enables the user to hear the sound segments separately in a process identical or similar to the process in an embodiment described above. Playing the sound segments by at least partially overlapping the sound segments in time enables the user to quickly check the content of the external sound in a process identical or similar to the process in an embodiment described above.

In another embodiment, every time of the receipt of the second input, while playing a sound segment that has been played among the plurality of sound segments after the division, the controller 15 may additionally play the sound segment preceding the sound segment that has been played. This configuration enables the user to check the added sound segment while checking the sound segment that has been played.

In another embodiment, the controller 15 may fix a sound image position at which a sound segment to be additionally played is localized and change a sound image position at which the sound segment that has been played is localized depending on the number of times that the sound segment has been played. Fixing a sound image position at which a sound segment to be additionally played is localized enables the user to grasp a direction from which the added sound segment comes, that is, a direction from which the sound segment to be newly played comes. For a sound segment that has been played, changing a sound image position at which the sound segment is localized depending on the number of times that the sound segment has been played enables the user to grasp to which playback, counting from the first playback, the sound segment corresponds depending on the direction from which the sound segment comes.

In another embodiment, the controller 15 may adjust a volume level of a sound segment that has been played in such a manner that the volume level of the sound segment that has been played decreases as the number of times that the sound segment has been played increases. This configuration enables the user to pay attention to sound segments that are played a small number of times.

In another embodiment, the configuration and the effect of the sound output device 1 are the same as or similar to those of an embodiment described above.

In an embodiment, (1) a sound output device includes
a storage configured to store external sound data; and
a controller configured to divide the external sound data into a plurality of sound segments,
   localize at least a part of the plurality of sound segments at respective sound image positions, and
   play the plurality of sound segments by at least partially overlapping the plurality of sound segments in time.

(2) In the sound output device described in (1),
the controller may make a start timing of playing each of the plurality of sound segments different.

(3) In the sound output device described in (1) or (2),
the controller may play the plurality of sound segments at a frequency that differs from a frequency of a corresponding part in the external sound.

(4) In the sound output device described in any one of (1) to (3),
the controller may localize two temporally continuous sound segments among the plurality of sound segments at two adjacent sound image positions among the plurality of sound image positions.

(5) In the sound output device described in any one of (1) to (4),
the controller may play the external sound beginning at a sound segment selected by a user among the plurality of sound segments that have been played.

(6) In the sound output device described in any one of (1) to (5),
the controller may play a sound segment following the sound segment selected by the user, after playing the sound segment selected by the user.

(7) In the sound output device described in any one of (1) to (6),
the controller may divide the external sound data into the plurality of sound segments by dividing the external sound data at equal time intervals.

(8) In the sound output device described in any one of (1) to (7),
the controller may divide the external sound data during a preset time interval that ends at a current time that is stored in the storage into the plurality of sound segments upon receiving a first input.

(9) In the sound output device described in any one of (1) to (8),
the controller may localize at respective sound image positions that differ from each other a same number of sound segments as a number of times that a second input has been received and play the sound segments by at least partially overlapping the sound segments in time.

(10) In the sound output device described in any one of (1) to (9),
the controller may additionally play a sound segment that has been played and a sound segment preceding the sound segment that has been played among the plurality of sound segments every time of the receipt of the second input.

(11) In the sound output device described in any one of (1) to (10),
the controller may fix a sound image position at which a sound segment to be additionally played is localized and change a sound image position at which the sound segment that has been played is localized depending on a number of times that the sound segment has been played.

(12) In the sound output device described in any one of (1) to (11),
the controller may localize a sound segment that has been played and another sound segment preceding the sound segment that has been played at sound image positions in accordance with a temporal order of the sound segment that has been played and the other sound segment preceding the sound segment that has been played in the external sound.

(13) In the sound output device described in any one of (1) to (12),
the controller may adjust a volume level of the sound segment that has been played in such a manner that the volume level of the sound segment that has been played decreases as the number of times that the sound segment has been played increases.

In an embodiment, (14) a sound output method includes
storing external sound data;
dividing the external sound data into a plurality of sound segments;
localizing at least a part of the plurality of sound segments at respective sound image positions; and
playing the plurality of sound segments by at least partially overlapping the plurality of sound segments in time.

In an embodiment, (15) a program is configured to cause a computer to execute a process including:
storing external sound data;
dividing the external sound data into a plurality of sound segments;
localizing at least a part of the plurality of sound segments at respective sound image positions; and
playing the plurality of sound segments by at least partially overlapping the plurality of sound segments in time.

Embodiments of the present disclosure have been described based on the drawings and the examples. Note that those skilled in the art easily make various changes or corrections based on the present disclosure. Accordingly, note that those changes or corrections are within the scope of the present disclosure. For example, a function or the like included in each functional unit may be rearranged in a logically compatible manner. Combining multiple functional units or the like into one or dividing a functional unit or the like is possible. Each embodiment according to the present disclosure described above need not be practiced so as to literally conform to the description of the embodiment, and each feature may be combined with another feature or may be partially omitted as appropriate in practicing each embodiment. In short, based on the present disclosure, those skilled in the art are able to make various changes and corrections to the content of the present disclosure. Accordingly, those changes and corrections are within the scope of the present disclosure. For example, each functional unit, each method, each step, or the like in each embodiment may be added to another embodiment or may be replaced by each functional unit, each method, each step, or the like in another embodiment in a logically compatible manner. Combining multiple functional units, multiple methods, multiple steps, or the like into one or dividing a functional unit, a method, a step, or the like is possible in each embodiment. Each embodiment according to the present disclosure described above need not be practiced so as to literally conform to the description of the embodiment, and each feature may be combined with another feature or may be partially omitted as appropriate in practicing each embodiment.

For example, in the sound output device 1, the controller 15 may receive the first input and then receive the second input. For example, the controller 15 may proceed to the process in step S22 as illustrated in FIG. 9 after the process in step S9 as illustrated in FIG. 4. In this case, among the steps illustrated in FIG. 9, the controller 15 need not execute a step whose process overlaps a process in FIG. 4. For example, the controller 15 need not execute the processes in steps S23, S24, S25, S26, and S27 as illustrated in FIG. 9.

For example, the controller 15 in the sound output device 1 may execute the process in step S12 during the execution of step S13 as illustrated in FIG. 4, that is, during the playback of the external sound. If the controller 15 determines that an input has been received to select any one of the plurality of sound segments (step S12: YES), the controller 15 may play via the loudspeaker unit 10 the external sound beginning at the newly selected sound segment. In a process identical or similar to the process in steps S12 and 13, the controller 15 may execute the process in step S32 during the execution of step S33 as illustrated in FIG. 9.

For example, an embodiment is also possible that causes a general-purpose computer to serve as the sound output device 1 according to an embodiment described above.

Specifically, a memory in a general-purpose computer stores a program describing a process to implement each function of the sound output device 1 according to an embodiment described above, and a processor is caused to load and execute the program. Accordingly, the present disclosure may be implemented in a form of a program executable by the processor or a non-transitory computer-readable medium storing the program.

In the present disclosure, expressions such as “first” and “second” are identifiers to distinguish the configurations. Ordinal numbers may be exchanged between the configurations distinguished by the expressions such as “first” and “second” in the present disclosure. For example, the identifiers “first” and “second” may be exchanged between the first input and the second input. The identifiers are exchanged simultaneously. The configurations are distinguished after the exchange of the identifiers. The identifiers may be removed. The configurations are distinguished by symbols after the identifiers are removed. Neither the order of the configurations nor the presence of an identifier having a small number is to be assumed only based on the expressions of the identifiers such as “first” and “second” in the present disclosure.

### REFERENCE SIGNS

1 sound output device
1F fixing member
1L, 1R housing
2A, 2B, 2C, 2D, 2E sound image position
2a, 2a1, 2b, 2c, 2d, 2e sound segment
3 electronic device
3a, 3b, 3c, 3d, 3e position
10 loudspeaker unit
11 microphone unit
12 input unit
13 communicator
14 storage
15 controller

1. A sound output device comprising:
a storage configured to store external sound data; and
a controller configured to divide the external sound data into a plurality of sound segments,
localize at least a part of the plurality of sound segments at respective sound image positions, and
play the plurality of sound segments by at least partially overlapping the plurality of sound segments in time.

2. The sound output device according to claim 1,
wherein the controller is configured to make a start timing of playing each of the plurality of sound segments different.

3. The sound output device according to claim 1,
wherein the controller is configured to play the plurality of sound segments at a frequency that differs from a frequency of a corresponding part in the external sound.

4. The sound output device according to claim 1,
wherein the controller is configured to localize two temporally continuous sound segments among the plurality of sound segments at two adjacent sound image positions among the plurality of sound image positions.

5. The sound output device according to claim 1,
wherein the controller is configured to play the external sound beginning at a sound segment selected by a user among the plurality of sound segments that have been played.

6. The sound output device according to claim 5,
wherein the controller is configured to play a sound segment following the sound segment selected by the user, after playing the sound segment selected by the user.

7. The sound output device according to claim 1,
wherein the controller is configured to divide the external sound data into the plurality of sound segments by dividing the external sound data at equal time intervals.

8. The sound output device according to claim 1,
wherein the controller is configured to divide the external sound data during a preset time interval that ends at a current time that is stored in the storage into the plurality of sound segments upon receiving a first input.

9. The sound output device according to claim 1,
wherein the controller is configured to localize at respective sound image positions that differ from each other a same number of sound segments as a number of times that a second input has been received and play the sound segments by at least partially overlapping the sound segments in time.

10. The sound output device according to claim 9,
wherein the controller is configured to additionally play a sound segment that has been played and a sound segment preceding the sound segment that has been played among the plurality of sound segments every time of the receipt of the second input.

11. The sound output device according to claim 10,
wherein the controller is configured to fix a sound image position at which a sound segment to be additionally played is localized and change a sound image position at which the sound segment that has been played is localized depending on a number of times that the sound segment has been played.

12. The sound output device according to claim 9,
wherein the controller is configured to localize a sound segment that has been played and another sound segment preceding the sound segment that has been played at sound image positions in accordance with a temporal order of the sound segment that has been played and the other sound segment preceding the sound segment that has been played in the external sound.

13. The sound output device according to claim 10,
wherein the controller is configured to adjust a volume level of the sound segment that has been played in such a manner that the volume level of the sound segment that has been played decreases as the number of times that the sound segment has been played increases.

14. A sound output method comprising:
storing external sound data;
dividing the external sound data into a plurality of sound segments;
localizing at least a part of the plurality of sound segments at respective sound image positions; and
playing the plurality of sound segments by at least partially overlapping the plurality of sound segments in time.

15. A program configured to cause a computer to execute a process comprising:
storing external sound data;
dividing the external sound data into a plurality of sound segments;
localizing at least a part of the plurality of sound segments at respective sound image positions; and
playing the plurality of sound segments by at least partially overlapping the plurality of sound segments in time.
